(19) United States
(12) Patent Application Publication
(10) Pub. No.: US 2021/0191723 A1
(43) Pub. Date: Jun. 24, 2021

(54) CHIP INCLUDING PROCESSOR AND EXCEPTION HANDLING METHOD THEREOF

(71) Applicant: REALTEK SEMICONDUCTOR CORP., Hsinchu (TW)

(72) Inventor: Han-Chieh Hsieh, Hsinchu (TW)

(73) Assignee: REALTEK SEMICONDUCTOR CORP., Hsinchu (TW)

(21) Appl. No.: 17/123,723

(22) Filed: Dec. 16, 2020

(30) Foreign Application Priority Data
Dec. 23, 2019 (TW) 108147275

(51) Int. Cl. G06F 9/30; G06N 3/08

(52) U.S. Cl. CPC G06F 9/30072; G06N 3/08

(57) ABSTRACT

A chip is capable of executing an exception handling method. The chip includes a processor. The processor includes a control circuit, a voltage detection circuit, a neural network circuit, and a processing circuit. The control circuit is configured to read and execute an instruction. The voltage detection circuit is configured to detect a voltage of the processor to output a voltage value. The neural network circuit outputs an output signal according to the voltage value and the instruction. The processing circuit executes an exception process when the output signal is abnormal. Therefore, the chip can predict whether the processor may operate at a voltage less than a rated voltage and take a corresponding measure, to ensure normal operation of the chip.

### CROSS-REFERENCE TO RELATED APPLICATION

This non-provisional application claims priority under 35 U.S.C. § 119(a) to Patent Application No. 108147275 in Taiwan, R.O.C. on Dec. 23, 2019, the entire contents of which are hereby incorporated by reference.

### BACKGROUND

### Technical Field

The present disclosure relates to a chip and an exception handling method thereof, and in particular, to a chip including a processor and an exception handling method thereof.

### Related Art

A system on a chip (SoC) is an integrated circuit with a plurality of functional elements, such as a central processing unit (CPU), a memory, a logic element, and an analog element.

When the SoC operates, the SoC is powered by an external power supply, and the SoC supplies power to the internal elements. The SoC enables the internal elements to operate according an external request of the chip. At a specific request, an internal element may operate at a full load state or an almost full load state. When an internal element operates at an almost full load state, power consumption of the internal element increases and the increasing power consumption may generate a significant current change and cause a decrease of a voltage of power supplied to the internal element. In some situations, when the decreased voltage is less than a rated voltage of the internal element, the internal element fails to operate normally or stops operation. The foregoing situation usually occurs in an internal element such as a CPU. However, behaviors of the CPU are extremely complex, and actually, it is rather difficult for a designer to predict, through simulation, in which application scenario or during which operation the CPU is prone to undervoltage due to the significant current change.

### SUMMARY

In view of the above, the inventor provides a chip including a processor and an exception handling method, to decrease the situations in which the processor fails to operate normally due to a decrease of a voltage supplied to the processor.

According to some embodiments, the chip includes a processor. The processor includes a memory, a control circuit, a voltage detection circuit, a neural network circuit, and a processing circuit. The memory is configured to store at least one instruction. The control circuit is configured to read and execute the at least one instruction. The voltage detection circuit is configured to detect a voltage of the processor to output a voltage value. The neural network circuit includes a plurality of functions and a plurality of parameters, and the neural network circuit is configured to operate in a training mode or a prediction mode. When the neural network circuit operates in the prediction mode, the neural network circuit outputs an output signal according to the at least one instruction read by the control circuit, the functions, and the parameters. When the neural network circuit operates in the training mode, the neural network circuit adjusts the parameters according to the at least one instruction read by the control circuit, the functions, and the voltage value. The processing circuit is configured to execute an exception process when the output signal is abnormal.

According to some embodiments, the processing circuit determines a mode command according to the voltage value, a voltage threshold, and the output signal; when the mode command is a training, the processing circuit controls the neural network circuit to operate in the training mode, and when the mode command is a prediction, the processing circuit controls the neural network circuit to operate in the prediction mode.

According to some embodiments, the neural network circuit operates in the training mode according to an external command.

According to some embodiments, the exception process executed by the processing circuit is instructing, by the processing circuit, the control circuit to pause or decrease reading of the at least one instruction, until the output signal is normal.

According to some embodiments, the chip further includes a chip circuit, where the chip circuit is coupled to the processing circuit, and the exception process executed by the processing circuit is instructing the chip circuit to increase a voltage supplied to the processor.

According to some embodiments, the processor further includes an operation circuit, and the control circuit controls the memory and the operation circuit to execute the read at least one instruction.

According to some embodiments, the processor further includes a clock generating circuit configured to generate a clock, the processor operates according to the clock, and the exception process executed by the processing circuit is adjusting the clock generating circuit to reduce a frequency of the clock.

According to some embodiments, the exception handling method is applicable to a processor. The exception handling method includes reading at least one instruction; executing the at least one instruction; obtaining, by using a neural network circuit of the processor, an output signal according to the at least one instruction, a plurality of functions of the neural network circuit, and a plurality of parameters of the neural network circuit; and executing an exception process when the output signal is abnormal.

According to some embodiments, the exception process is pausing or decreasing reading of the at least one instruction, until the output signal is normal.

According to some embodiments, the exception process is sending an external command to increase a voltage of the processor 30.

According to some embodiments, the exception process is reducing a frequency of a clock of the processor 30.

To sum up, according to some embodiments, the processor can predict whether a received voltage may be less than a voltage threshold. The processor takes a corresponding measure when the received voltage would be less than the voltage threshold, to avoid that the processor fails to operate normally due that the voltage received by the processor decreases to be less than the voltage threshold. In this way, normal operation of the chip can be ensured.

### BRIEF DESCRIPTION OF THE DRAWINGS

FIG. 1 is a schematic circuit block diagram of a chip according to some embodiments;

FIG. 2 is a schematic circuit block diagram of a chip according to some embodiments;

FIG. 3 is a schematic circuit block diagram of a neural network circuit of a chip according to some embodiments;

FIG. 4 is a schematic circuit block diagram of a chip according to some embodiments; and

FIG. 5 is a flowchart of an exception handling method according to some embodiments.

### DETAILED DESCRIPTION

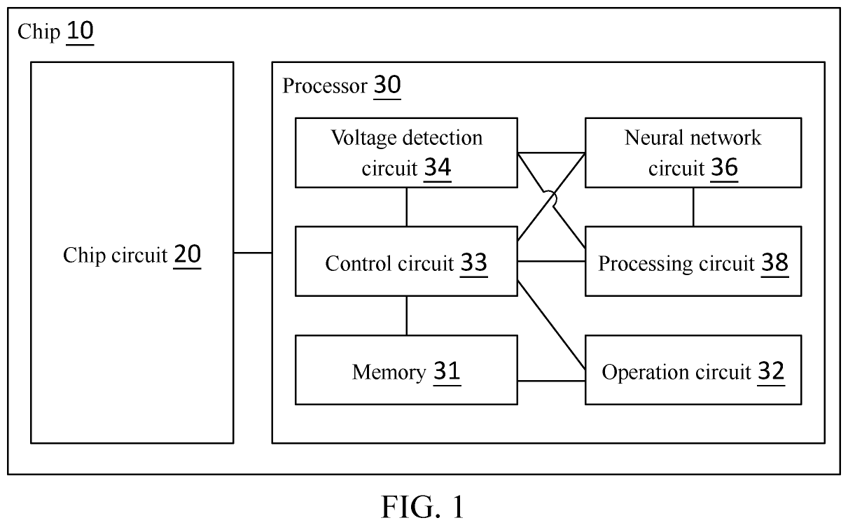

FIG. 1 is a schematic circuit block diagram of a chip according to some embodiments. According to some embodiments, the chip 10 includes a processor 30. According to some embodiments, the chip 10 includes a chip circuit 20 and a processor 30.

The chip 10 is a chip including the processor 30, for example, the chip 10 is, but not limited to, a system on a chip (SOC). The chip circuit 20 is a circuit other than the processor 30 in the chip. In some embodiments, the chip 10 is a SoC including a central processing unit (CPU), that is, the processor 30 is the CPU of the SoC, and the chip circuit 20 is other circuits of the SoC except the CPU. For example, the chip circuit 20 may be a power supply management circuit, a memory, a peripheral interface circuit, a bus, a specific functional circuit, or an output/input port. The peripheral interface circuit is, for example, but not limited to, an inter-integrated circuit (I²C), and a universal serial bus (USB). The power supply management circuit of the chip circuit 20 may control a voltage of power supplied to the processor 30.

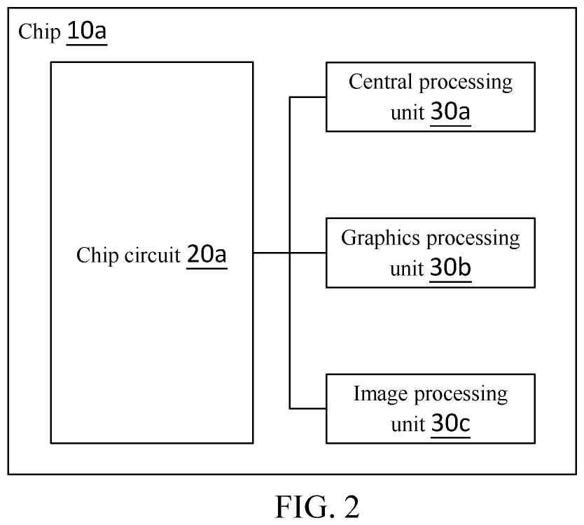

FIG. 2 is a schematic circuit block diagram of a chip according to some embodiments. In some embodiments, the chip 10a includes a plurality of processors 30 and a chip circuit 20a. In this embodiment, the processors 30 are a CPU 30a, a graphics processing unit (GPU) 30b, and an image processing unit 30c, respectively. The chip circuit 20a is a circuit of the chip other than the three processors 30a, 30b, and 30c. For example, the chip circuit 20a is, but not limited to, a memory and a peripheral interface circuit. The peripheral interface circuit is, for example, a universal asynchronous receiver/transmitter (UART), a serial peripheral interface (SPI), a display interface, a high definition multimedia interface (HDMI), and/or a mobile industry processor interface (MIPI). The memory is, for example, a flash and/or a dynamic random access memory (DRAM). In some embodiments, at least one of the processors 30a, 30b, and 30c is the processor 30 having a circuit block diagram shown in FIG. 1.

In some embodiments, in addition to the CPU 30a, the GPU 30b, and the image processing unit 30c, the chip 10 further includes a video processing unit (not shown in the figure). A circuit block diagram of at least one of the CPU 30a, the GPU 30b, the image processing unit 30c, and the video processing unit is similar to the processor 30 shown in FIG. 1.

An external power is supplied to the chip 10 for the chip's operation. The chip 10 supplies power to the chip circuit 20 and the processor 30.

Referring to FIG. 1, in some embodiments, the processor 30 includes a memory 31, a control circuit 33, a voltage detection circuit 34, a neural network circuit 36, and a processing circuit 38. Operation of an internal circuit of the processor 30 is described below by using the CPU 30a as an example. In this embodiment, the memory 31 is a memory inside the processor 30, but the present invention is not limited thereto. In another embodiment, the memory 31 may be a memory outside the processor 30, and the processor 30 is coupled to the memory 31.

The processor 30 is configured to be connected to the chip circuit 20. The chip circuit 20 and the processor 30 are connected to each other by using, for example, but not limited to, a control signal, a data bus, and an address bus (an external bus of the processor 30).

In addition to the foregoing circuits, the processor 30 may further include a bus (which may also be referred to as an internal bus of the processor 30). The bus is, for example, but not limited to, an address bus, a data bus, and a control bus.

The memory 31 is configured to store at least one instruction and a plurality of data. In the embodiment of FIG. 1, the memory 31 is an internal memory of the processor 30. The memory 31 may be, but not limited to, any one or any combination of a static random access memory (SRAM), an instruction register, an address register, a general-purpose register, a flag register, and a cache memory. An instruction stored in the memory 31 is, for example, but not limited to, a reduced instruction set (RISC) and/or a complex instruction set (CISC). The control circuit 33 and an operation circuit 32 use data stored in the memory 31 to perform operation according to the instruction.

The control circuit 33 is configured to read the at least one instruction and to execute the read at least one instruction. For example, if the control circuit 33 reads an “addition” instruction from the memory 31, the control circuit 33 performs an addition operation.

In some embodiments, the processor 30 includes a memory 31, an operation circuit 32, a control circuit 33, a voltage detection circuit 34, a neural network circuit 36, and a processing circuit 38. The memory 31 is configured to store a plurality of instructions and a plurality of pieces of data. The operation circuit 32 may be but is not limited to an arithmetic logic unit. The arithmetic logic unit is configured to perform a mathematical operation and a logic operation, move data, and the like. In some embodiments, the operation circuit 32 is a floating-point unit. In some embodiments, the operation circuit 32 includes an arithmetic logic unit and a floating-point unit. The control circuit 33 is configured to read the instructions sequentially and control the memory 31 and the operation circuit 32, to perform an operation corresponding to the read instructions. For example, if the control circuit 33 reads an addition instruction from the memory 31, the control circuit 33 controls the operation circuit 32 to perform an addition operation on a value (the data) stored in the memory 31.

The voltage detection circuit 34 is configured to detect a voltage of the processor 30 to output a voltage value. As described above, the chip 10 supplies power to the processor 30. The voltage detection circuit 34 is configured to detect a voltage of the power received by the processor 30 and output the voltage value. As described above, the processor 30 operates according to the instruction stored in the memory, and when power consumption required in the operation of the processor 30 is relatively large, the voltage value detected by the voltage detection circuit 34 changes accordingly. In some embodiments, the voltage detection circuit 34 is, but not limited to, an analog circuit.

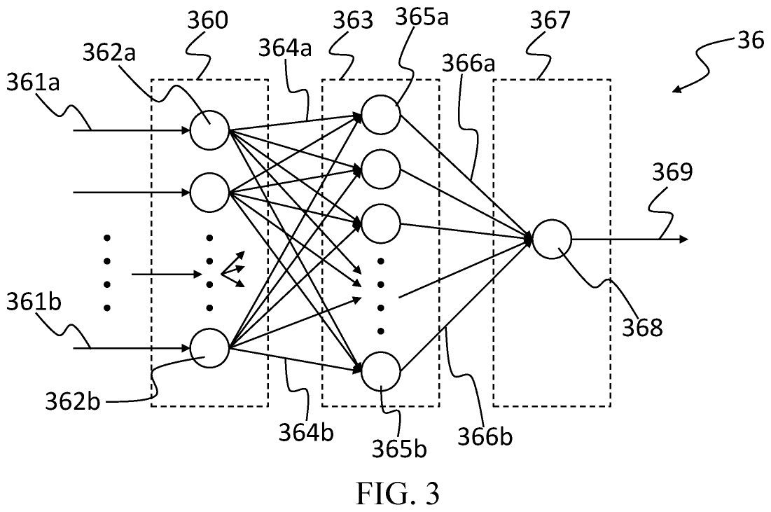

The neural network circuit 36 may be but is not limited to a feedforward neural network, a recurrent neural network, or a recursive neural network. FIG. 3 is a schematic circuit block diagram of a neural network circuit of a chip according to some embodiments. The neural network circuit 36 in FIG. 3 is a feedforward neural network. According to some embodiments, the neural network circuit 36 includes a plurality of functions and a plurality of parameters. The neural network circuit 36 is configured to be controlled to operate in a training mode or a prediction mode. When the neural network circuit 36 operates in the prediction mode, the neural network circuit 36 outputs an output signal according to the instructions read by the control circuit 33, the functions, and the parameters, and when the neural network circuit 36 operates in the training mode, the neural network circuit 36 adjusts the parameters according to the instructions read by the control circuit 33, the functions, and the voltage value detected by the voltage detection circuit 34.

In some embodiments, the neural network circuit 36 includes an input layer 360, a hidden layer 363, and an output layer 367. The input layer 360 includes a plurality of input ports 361a and 361b and a plurality of neurons 362a and 362b. The hidden layer 363 includes a plurality of neurons 365a and 365b, a plurality of input connections 364a and 364b, and a plurality of output connections 366a and 366b. The output layer 367 includes a neuron 368 and an output port 369. The input connections 364a and 364b are configured to correspondingly connect each of the neurons 362a and 362b of the input layer 360 to each of the neurons 365a and 365b of the hidden layer 363, and the output connections 366a and 366b are configured to connect each of the neurons 365a and 365b of the hidden layer 363 to the neuron 368 of the output layer 367.

The input ports 361a and 361b are configured to receive external data from the neural network circuit 36. By using the processor 30 in FIG. 1 as an example, the input ports 361a and 361b are configured to receive the instructions read by the control circuit 33. Therefore, a quantity of the input ports 361a and 361b is less than or equal to a quantity of the types of the instructions. For example, the quantity of the types of the instructions of the control circuit 33 is 10, and in some embodiments, the quantity of the input ports 361a and 361b is same as the quantity of the types of the instructions. In some embodiments, six types of the instructions in the types of the instructions are selected as inputs of the input ports 361a and 361b, where the selected types of instructions may be the types of instructions that greatly affect power consumption of the processor 30, and are, for example, but not limited to, a floating-point operation instruction and an integer operation instruction.

After receiving the input data, each of the neurons 362a and 362b of the input layer 360 transmits the input data to the neurons 365a and 365b of the corresponding hidden layer 363 through the input connections 364a and 364b. Each of the neurons 365a and 365b of the hidden layer 363 receives the input data from each of the neurons 362a and 362b of the input layer 360, and obtains, according to a corresponding function, a calculation result for each of received input data. Then each of the neurons 365a and 365b of the hidden layer 363 obtains an integration result according to an integration function and the calculation results and uses the integration result as output data of each of the neurons 365a and 365b. In some embodiments, the foregoing corresponding function and the integration function are shown in the following equation (1):

Σᵢ₌₀ⁿwᵢxᵢ+b equation (1),

where

i indicates numbers of the neurons 362a and 362b of the input layer 360, n is a quantity of the neurons 362a and 362b of the input layer 360, wi is a weighting of the input data received by each of the neurons 365a and 365b of the hidden layer 363 from each of the neurons 362a and 362b of the input layer 360, xi is the received input data, and b is a bias. Therefore, the foregoing corresponding function is that “the input data of each of the neurons 362a and 362b of the input layer 360 is multiplied by the weighting of the input data, and added by the bias of the input data”. The integration function is a sum operation, that is, each of the neurons 365a and 365b of the hidden layer 363 is calculated by using the corresponding function, and then the calculated neurons 365a and 365b are added and are used as an output of the neurons 365a and 365b of the hidden layer 363. In some embodiments, the corresponding functions of all the neurons 365a and 365b of the hidden layer 363 may be the same, partially the same, or different from each other. The integration functions of the neurons 365a and 365b of the hidden layer 363 may be the same, partially the same, or different from each other, which is determined according to a design and an application request of the neural network circuit 36.

Similarly, the neuron 368 of the output layer 367 also has a plurality of corresponding functions and an integration function. The neuron 368 obtains an output of the neuron 368 according to the corresponding functions, the integration function, and the output from each of the neurons 365a and 365b of the hidden layer 363. The corresponding functions of the neuron 368 of the output layer 367 may be the same as or different from one of the corresponding functions of the neurons 365a and 365b of the hidden layer 363. The integration function of the neuron 368 of the output layer 367 may be the same as or different from one of the integration functions of the neurons 365a and 365b of the hidden layer 363.

An integration result of the neuron 368 of the output layer 367 is converted by using a transfer function, and the converted integration result is output through the output port 369.

The weightings and the biases of the corresponding functions of the hidden layer 363 and the output layer 367 are the parameters when the neural network circuit 36 operates, and the corresponding functions and the integration function are the functions when the neural network circuit 36 operates (in the training mode or the prediction mode).

The neural network circuit 36 in FIG. 3 includes a hidden layer 363. In some embodiments, the neural network circuit 36 includes a plurality of hidden layers 363. In some embodiments, the neural network circuit 36 includes two hidden layers 363 (referred to as a first hidden layer and a second hidden layer respectively), each neuron of the first hidden layer is connected to each neuron of the second hidden layer, and each neuron includes a corresponding function and an integration function. The operation of the neural network circuit 36 is similar to that above, and details are not described again.

In the embodiment of FIG. 3, the output layer 367 includes a neuron 368. In some embodiments, the output layer 367 may include a plurality of neurons 368, which is determined according to its application.

In some embodiments, input signals of the neural network circuit 36 in FIG. 3 are the instructions read by the control circuit 33. For example, the input data of the neural network circuit 36 indicates whether each type of instructions are operating at each moment (a digital signal “0” may be used to represent “not in operation”, and a digital signal “1” may be used to represent “in operation”). The neural network circuit 36 obtains an output result according to the input data (the instructions read by the controller), the functions (the corresponding functions and the integration function), and the parameters, and outputs the output result through the output port 369.

In some embodiments, both an input and an output of the neural network circuit 36 are a digital signal 0 or 1. The voltage value is converted into a digital signal first, and the conversion may be performed by the voltage detection circuit 34, the neural network circuit 36, or a conversion circuit (not shown in the figure) between the neural network circuit 36 and the voltage detection circuit 34. In some embodiments, in the conversion, the voltage value is compared with a voltage threshold, and when the voltage value is less than the voltage threshold, a digital signal 1 is output. Otherwise, a digital signal 0 is output. The voltage threshold may be but is not limited to a rated voltage of the processor 30, that is, when the voltage value is less than the voltage threshold (the digital signal 1), the processor 30 may fail to operate normally. In some embodiments, the digital signal 0 represents that the voltage value is less than the voltage threshold, and the digital signal 1 represents that the voltage value is not less than the voltage threshold. Second, when the neural network circuit 36 is controlled to operate in the prediction mode, the output signal output by the neural network circuit 36 according to the instructions read by the control circuit 33, the functions, and the parameters is also a digital signal 0 or 1. In some embodiments, the output signal being a digital signal 1 indicates “abnormal”, and the output signal being a digital signal 0 indicates “normal”.

The neural network circuit 36 is controlled to operate in the training mode or the prediction mode. In some embodiments, before the parameters of the neural network circuit 36 are determined, a user may give an external command to the chip 10 by using a host (not shown in the figure). The chip circuit 20 sends a compulsory command to the processor 30 according to the external command, and the neural network circuit 36 operates in the training mode according to the compulsory command, to enable, for example, but not limited to, the chip 10 to operate at a pressure test load. In some embodiments, the neural network circuit 36 operates in the training mode according to the external command. When the neural network circuit 36 operates in the training mode, the neural network circuit 36 adjusts the parameters according to the instructions read by the control circuit 33, the functions, and the voltage value. Specifically, when the neural network circuit 36 operates in the training mode, the neural network circuit 36 uses the instructions as inputs, and adjusts the parameters according to the corresponding functions and the integration functions of the hidden layer 363 and the output layer 367. When the output signal obtained by the neural network circuit 36 through an operation according to the instructions, the functions, and parameters is consistent with the voltage value detected by the voltage detection circuit 34, the parameters are fixed.

In some embodiments, to enable the neural network circuit 36, according to the parameters and the functions, to more accurately output the output signal consistent with the voltage value detected by the voltage detection circuit 34, the user controls, by using the external command, the neural network circuit 36 to operate in the training mode.

When the neural network circuit 36 operates in the prediction mode and the output signal is abnormal, the processing circuit 38 executes an exception process. Otherwise, when the output signal is “normal”, the processing circuit 38 does not execute the exception process.

In some embodiments, the processing circuit 38 determines a mode command according to the voltage value, the voltage threshold, and the output signal. When the mode command is a “training”, the processing circuit 38 controls the neural network circuit 36 to operate in the training mode, and when the mode command is a “prediction”, the processing circuit 38 controls the neural network circuit 36 to operate in the prediction mode. Specifically, when the neural network circuit 36 operates in the prediction mode, the processing circuit 38 compares the output signal with the voltage value (the voltage value after a comparison is made with the voltage threshold). When the two are different (indicating that the output signal when the neural network circuit 36 makes a prediction is not consistent with the voltage value), the processing circuit 38 controls the neural network circuit 36 to operate in the training mode, and the neural network circuit 36 obtains the parameters according to the instructions, the functions, and voltage value. When the result of the comparison made by the processing circuit 38 is that the output signal is the same as the voltage value, the processing circuit 38 controls the neural network circuit 36 to operate in the prediction mode.

The processing circuit 38 executes the exception process when the output signal is abnormal. In some embodiments, the exception process is instructing, by the processing circuit 38, the control circuit 33 to pause or decrease reading of the at least one instruction, until the output signal is normal. Therefore, the processor 30 can avoid continuously executing an instruction which consumes relatively large power and avoid the situation of the decrease of the voltage. When the output signal of the neural network circuit 36 is “normal”, the processing circuit 38 stops the exception process. In this embodiment, the processing circuit 38 instructs the control circuit 33 to restore to read the instructions.

In some embodiments, the exception process is instructing, by the processing circuit 38, the control circuit 33 to postpone an operation of a specific instruction, until the output signal is normal. Specifically, the specific instruction is an instruction which consumes relatively large power, for example, but not limited to, a floating-point operation instruction. Therefore, the processor 30 can avoid immediately executing an instruction which consumes relatively large power, to avoid the situation of the decrease of the voltage. When the output signal of the neural network circuit 36 is “normal”, the processing circuit 38 stops the exception process. In this embodiment, the processing circuit 38 instructs the control circuit 33 to restore to execute the specific instruction.

In some embodiments, the exception process is instructing, by the processing circuit 38, the chip circuit 20 to increase a voltage supplied to the processor 30. For example, the processing circuit 38 increases the voltage supplied to the processor 30 by 10% to 20% by using a power supply management circuit (not shown in the figure) of the chip circuit 20. The voltage increase percentage may be adjusted according to an actual request. Therefore, the voltage received by the processor 30 will not decrease to a level on which the processor 30 fails to operate normally. Next, when the output signal of the neural network circuit 36 is “normal”, the processing circuit stops the exception process. In this embodiment, the processing circuit 38 instructs the chip circuit 20 to restore to normal power supply.

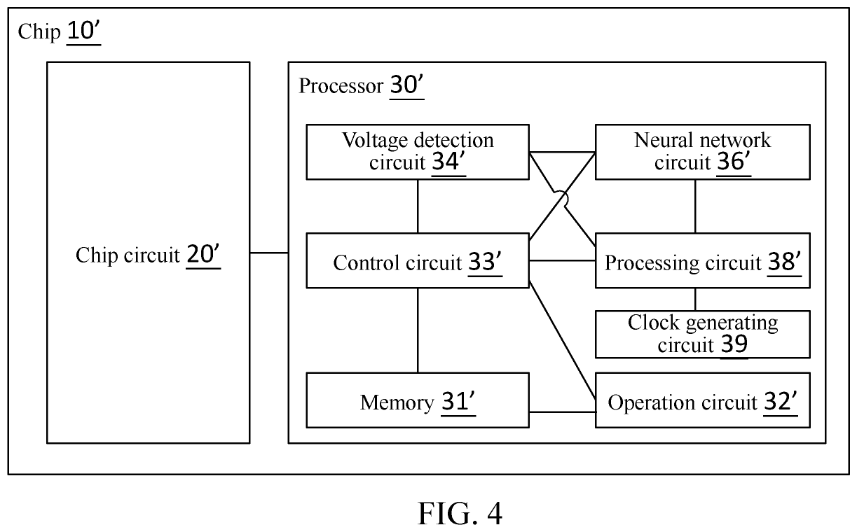

FIG. 4 is a schematic circuit block diagram of a chip according to some embodiments. The chip 10′ includes a chip circuit 20′ and a processor 30′. The processor 30′ includes a memory 31′, an operation circuit 32′, a control circuit 33′, a voltage detection circuit 34′, a neural network circuit 36′, a processing circuit 38′, and a clock generating circuit 39. The clock generating circuit 39 is configured to generate a clock which is provided to hardware in the processor 30′. The processor 30′ operates according to the clock. In some embodiments, the memory 31′, the operation circuit 32′, the control circuit 33′, the processing circuit 38′, the voltage detection circuit 34′, and/or the neural network circuit 36′ of the processor 30′ operate(s) according to the clock, but the clock on which each circuit depends may be selected according to an actual request. The present invention is not limited thereto.

When the neural network circuit 36′ operates in the prediction mode and the output signal is abnormal, the processing circuit 38′ executes an exception process. In some embodiments, the exception process is adjusting and decreasing, by the processing circuit 38′, the clock of the processor 30. Therefore, after the clock is adjusted and decreased, an operating speed of the processor 30′ decreases, so that the situation of undervoltage of the processor 30′ due to excessive power consumption can be avoided.

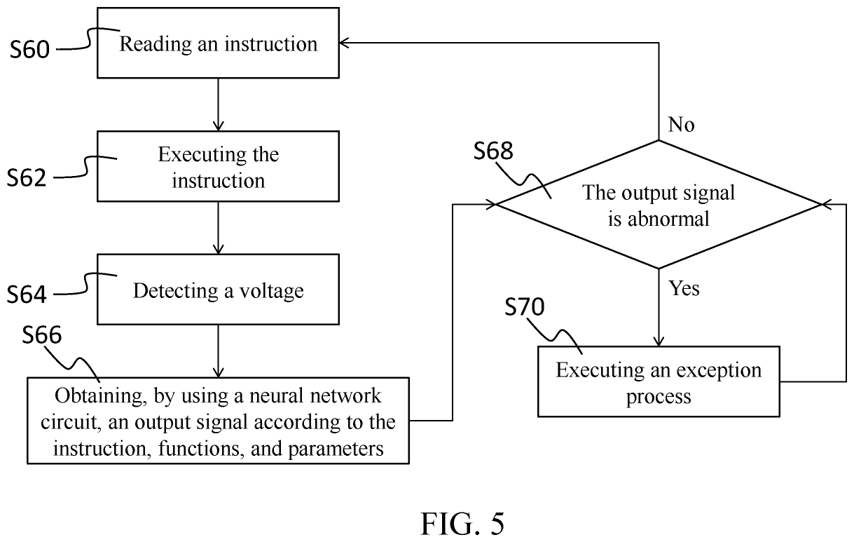

FIG. 5 is a flowchart of an exception handling method according to some embodiments. According to some embodiments, an exception handling method is applicable to a processor. The exception handling method includes

S60: reading at least one instruction;

S62: executing the at least one instruction;

S64: detecting a voltage of the processor to obtain a voltage value;

S66: obtaining, by using a neural network circuit of the processor, an output signal according to the at least one instruction, a plurality of functions of the neural network circuit, and a plurality of parameters of the neural network circuit; and

S68 and S70: executing an exception process when the output signal is abnormal.

Description is made below by using an example in which the exception handling method is performed on the processor 30 in FIG. 1. When the processor 30 performs S60, the control circuit 33 of the processor 30 reads an instruction stored in the memory 31. When the processor 30 performs S62, the control circuit 33 executes the at least one instruction. When the processor 30 performs S64, the voltage detection circuit 34 of the processor 30 detects and obtains a voltage value of power supplied to the processor 30. When the processor 30 performs S66, the neural network circuit 36 of the processor 30 obtains an output signal according to the at least one instruction, a plurality of functions of the neural network circuit, and a plurality of parameters of the neural network circuit. The output signal has two states: an abnormal state and a normal state. When the processor 30 performs S68, the processing circuit 38 of the processor 30 determines whether the output signal is abnormal. If the output signal is abnormal, the processing circuit 38 executes the exception process. When the output signal is normal, the processor 30 goes back to perform S60.

The foregoing steps S60 to S70 are not required to be performed sequentially. For example, in step S64, the voltage detection circuit 34 may detect and obtain the voltage value at any time. In step S66, the neural network circuit 36 may obtain the output signal at any time according to the at least one instruction, the functions, and the parameters. In step S68, when the neural network circuit 36 outputs the output signal, the processing circuit 38 determines whether the output signal is abnormal and determines whether to execute the exception process. When the output signal is normal, the processing circuit 38 of the processor 30 may still operate and continuously determine whether the output signal output by the neural network circuit 36 is abnormal. When the processing circuit 38 continuously determines whether the output signal is abnormal, the voltage detection circuit 34 continuously detects and obtains the voltage value and the control circuit 33 continuously reads and executes the at least one instruction. Therefore, when it is determined that the output signal is normal in S68 in FIG. 5, the processor 30 may perform S60, S64, S66, and S68 simultaneously. Specifically, that the control circuit 33 performs S60, that the voltage detection circuit 34 performs S64, that the neural network circuit 36 outputs the output signal, and that the processing circuit 38 determines whether the output signal is abnormal may be performed simultaneously, and there is no requirement on the sequence.

The exception process may be any one or any combination of the following embodiments: pausing or decreasing reading of the at least one instruction until the output signal is normal; sending an external command to increase the voltage of the processor 30; and reducing a frequency of a clock of the processor 30.

The above-mentioned “sending an external command to increase the voltage of the processor 30” may be that the processor 30 sends the external command to the chip circuit 20 or an external element of the chip 10, so that the chip circuit 20 increases a voltage of power supplied to the processor 30 or the external element of the chip 10 increases a voltage of power supplied to the chip 10 and the processor 30.

In some embodiments, in the exception handling method, the step S68 of obtaining the output signal includes controlling the neural network circuit 36 to operate in a prediction mode. Specifically, the processor 30 controls the neural network circuit 36 to operate in the prediction mode. In some embodiments, the chip circuit 20 or the chip 10 receives an external command, so that the neural network circuit 36 operates in the prediction mode.

In some embodiments, step S68 of obtaining the output signal includes controlling the neural network circuit 36 to operate in a training mode, and adjusting, by the neural network circuit 36, the parameters according to the at least one instruction, the functions, and the voltage value. In some embodiments, when the neural network circuit 36 has not operated in the training mode, the chip circuit 20 controls the neural network circuit 36 to operate in the training mode, or the chip 10 receives an external command to control the neural network circuit 36 to operate in the training mode. In some embodiments, when the neural network circuit 36 operates in the prediction mode, the processing circuit 38 compares the output signal of the neural network circuit 36 with the voltage value obtained by the voltage detection circuit 34. When the comparison result is that the output signal and the voltage value are inconsistent, the processing circuit 38 controls the neural network circuit 36 to operate in the training mode. When the neural network circuit 36 operates in the training mode, the neural network circuit 36 adjusts the parameters according to the at least one instruction, the functions, and the voltage value.

In some embodiments, an exception handling method includes reading at least one instruction (S60); executing the at least one instruction (S62); obtaining, by using a neural network circuit of the processor, an output signal according to the at least one instruction, a plurality of functions of the neural network circuit, and a plurality of parameters of the neural network circuit (S66); and executing an exception process when the output signal is abnormal (S68 and S70). The exception handling method in this embodiment is applied to the prediction mode. For example, when the processor 30 to which the exception handling method is applied has completed training of the neural network circuit 36 and the processor 30 performs an execution operation, the processor 30 may not enter. the training mode

To sum up, according to some embodiments, the processor can predict whether a received voltage may be less than a voltage threshold. The processor takes a corresponding measure when the received voltage would be less than the voltage threshold, to avoid that the processor fails to operate normally due that the voltage received by the processor decreases to be less than the voltage threshold. In this way, normal operation of the chip can be ensured.

What is claimed is:

1. A chip, comprising:
a processor, comprising:
a memory, configured to store at least one instruction;
a control circuit, configured to read and execute the at least one instruction;
a voltage detection circuit, configured to detect a voltage of the processor to output a voltage value; and
a neural network circuit, comprising a plurality of functions and a plurality of parameters, wherein the neural network circuit is configured to operate in a training mode or a prediction mode; when the neural network circuit operates in the prediction mode, the neural network circuit outputs an output signal according to the at least one instruction read by the control circuit, the functions, and the parameters, and when the neural network circuit operates in the training mode, the neural network circuit adjusts the parameters according to the at least one instruction read by the control circuit, the functions, and the voltage value; and
a processing circuit, configured to execute an exception process when the output signal is abnormal.

2. The chip according to claim 1, wherein the exception process executed by the processing circuit is instructing the control circuit to pause or decrease reading of the at least one instruction, until the output signal is normal.

3. The chip according to claim 1, further comprising a chip circuit, wherein the chip circuit is coupled to the processing circuit, and the exception process executed by the processing circuit is instructing the chip circuit to increase a voltage supplied to the processor.

4. The chip according to claim 1, wherein the processor further comprises a clock generating circuit configured to generate a clock, the processor operates according to the clock, and the exception process executed by the processing circuit is adjusting the clock generating circuit, to reduce a frequency of the clock.

5. The chip according to claim 1, wherein the processing circuit determines a mode command according to the voltage value, a voltage threshold, and the output signal; when the mode command is a training, the processing circuit controls the neural network circuit to operate in the training mode, and when the mode command is a prediction, the processing circuit controls the neural network circuit to operate in the prediction mode.

6. The chip according to claim 5, wherein the exception process executed by the processing circuit is instructing the control circuit to pause or decrease reading of the at least one instruction, until the output signal is normal.

7. The chip according to claim 5, further comprising a chip circuit, wherein the chip circuit is coupled to the processing circuit, and the exception process executed by the processing circuit is instructing the chip circuit to increase a voltage supplied to the processor.

8. The chip according to claim 5, wherein the processor further comprises a clock generating circuit configured to generate a clock, the processor operates according to the clock, and the exception process executed by the processing circuit is adjusting the clock generating circuit, to reduce a frequency of the clock.

9. The chip according to claim 1, wherein the neural network circuit operates in the training mode according to an external command.

10. The chip according to claim 9, wherein the processing circuit determines a mode command according to the voltage value, a voltage threshold, and the output signal; when the mode command is a training, the processing circuit controls the neural network circuit to operate in the training mode, and when the mode command is a prediction, the processing circuit controls the neural network circuit to operate in the prediction mode.

11. The chip according to claim 10, wherein the exception process executed by the processing circuit is instructing the control circuit to pause or decrease reading of the at least one instruction, until the output signal is normal.

12. The chip according to claim 10, further comprising a chip circuit, wherein the chip circuit is coupled to the processing circuit, and the exception process executed by the processing circuit is instructing the chip circuit to increase a voltage supplied to the processor.

13. The chip according to claim 12, wherein the processor further comprises an operation circuit, and the control circuit controls the memory and the operation circuit to execute the read at least one instruction.

14. The chip according to claim 10, wherein the processor further comprises a clock generating circuit configured to generate a clock, the processor operates according to the clock, and the exception process executed by the processing circuit is adjusting the clock generating circuit to reduce a frequency of the clock.

15. An exception handling method, applicable to a processor, the exception handling method comprising:
reading at least one instruction;
executing the at least one instruction;
obtaining, by using a neural network circuit of the processor, an output signal according to the at least one instruction, a plurality of functions of the neural network circuit, and a plurality of parameters of the neural network circuit; and
executing an exception process when the output signal is abnormal.

16. The exception handling method according to claim 15, wherein the exception process comprises pausing or decreasing reading of the at least one instruction until the output signal is normal.

17. The exception handling method according to claim 15, wherein the exception process comprises sending an external command to increase a voltage of the processor.

18. The exception handling method according to claim 15, wherein the exception process comprises reducing a frequency of a clock of the processor.

19. The exception handling method according to claim 15, wherein the obtaining the output signal comprises controlling the neural network circuit to operate in a prediction mode.

20. The exception handling method according to claim 15, wherein before the obtaining the output signal, the exception handling method further comprises detecting a voltage of the processor to obtain a voltage value, and the obtaining the output signal comprises:
controlling the neural network circuit to operate in a training mode; and
adjusting, by the neural network circuit, the parameters according to the at least one instruction, the functions, and the voltage value.
